(19) United States
(12) Patent Application Publication
(10) Pub. No.: US 2007/0056816 A1
(43) Pub. Date: Mar. 15, 2007

(54) Brake assembly with rust jacking

(75) Inventors: Roy Lee Hayford, Canton, MI (US); Joseph A. Kay, Highland, MI (US); Holly Ann Giangrande, Troy, MI (US)

Correspondence Address: GREGORY B. BEGGS;LAW OFFICES OF GREGORY B. BEGGS, 5100 FAIRVIEW ANVENUE, DOWNERS GROVE, IL, 60515, US

(73) Assignee: ArvinMeritor Technology, LLC, Troy, MI (US)

(21) Appl. No.: 11/606,831

(22) Filed: Nov. 30, 2006

(51) Int. Cl. F16D 65/04

(52) U.S. Cl. 188/250 B; 188/250 G

(57) ABSTRACT

A brake component assembly includes a support plate and a friction lining mounted to the support plate with a plurality of fasteners. A sealing barrier is formed between the support plate and the friction lining. A liquid material is initially applied to at least one of the support plate and friction lining, which are then fastened together. The liquid material subsequently forms the sealing barrier between the support plate and the friction lining. Optionally, a flexible gasket is used to form the sealing barrier. The flexible gasket is sandwiched between the support plate and friction lining when the support plate and friction lining are fastened together.

### TECHNICAL FIELD

The subject invention relates to a brake component assembly with a friction lining supported on a plate with a sealing barrier formed between the friction lining and plate.

### BACKGROUND OF THE INVENTION

Brake shoe and pad assemblies utilize a friction lining that is supported on a plate, which is often referred to as a brake table. Traditionally, an adhesive or a plurality of fasteners is used to attach the friction lining to the brake table. In response to a braking command, an actuator moves the brake shoe or pad assembly such that the friction lining contacts a rotating brake component, such as a drum or disc.

Corrosion or rust can develop at an interface between the brake table and friction lining. Over time this rust or corrosion can expand or grow, which can cause a separation of the friction lining from an outer surface of the brake table. This can deform the friction lining from its intended shape resulting in less efficient braking. Further, this expansion force, in combination with an attachment force of the adhesive or fastener, acting in an opposing direction from the expansion force, can cause the friction lining to crack. This can accelerate wear of the friction lining. Further, governmental restrictions can require a vehicle with cracked linings to be taken out of service. In this situation the friction linings are required to be changed before wear life is met.

It is known to provide a double-sided adhesive liner between the friction lining and brake table to protect against corrosion. This double-sided adhesive liner adheres to both the friction lining and the brake table. However, once a friction lining has worn, it is difficult and time consuming to replace the worn lining with a new friction lining due to the double-sided adhesive liner.

Thus, there is a need for a brake shoe or pad assembly that provides a sealing barrier to prevent corrosion, and which allows for easy replacement of new friction linings, as well as overcoming other deficiencies in the prior art.

### SUMMARY OF THE INVENTION

A brake pad or shoe assembly includes a sealing bearing that prevents corrosion between a friction lining and a support plate. A liquid material is initially applied to at least one of the support plate and friction lining. After application of the liquid material, the friction lining is fastened to the brake table with a plurality of fasteners. The liquid material subsequently forms the sealing barrier.

In one example, the liquid material is a silicon based material that can be sprayed or rolled onto either or both of the support plate and friction lining. In another example, the liquid material is applied as a bead of material on either or both of the support plate and friction lining.

In one example, the support plate is dipped into the liquid material such that the support plate is substantially coated with the liquid material.

In another example, the sealing barrier comprises a flexible gasket that is positioned between the support plate and the friction lining. The sealing barrier is made from a resilient rubber material or cork, for example, and is solely used to provide a sealed interface between the friction lining and the support plate. Fasteners are then used to secure the friction lining to the support plate.

The sealing barrier is solely relied upon to provide a sealed interface between the friction lining and the support plate. Fasteners are relied upon to secure the friction lining to the support plate. This configuration allows worn friction linings to be easily and efficiently replaced. The worn friction lining is removed from the support plate, liquid material is applied as discussed above, and a new friction lining is secured to the support plate.

In addition to allowing worn friction linings to be easily replaced, the subject sealing barrier prevents rust/corrosion from forming between the friction lining and support plate, which results in improved brake performance and longer friction lining life.

These and other features of the present invention can be best understood from the following specification and drawings, the following of which is a brief description.

### BRIEF DESCRIPTION OF THE DRAWINGS

FIG. 1 shows a perspective view of a drum brake assembly.

FIG. 2 is a perspective view of a brake shoe assembly from the drum brake assembly of FIG. 1.

FIG. 3 is one example of the brake shoe assembly of FIG. 2 with a sealing barrier.

FIG. 4 is another example of the brake shoe assembly of FIG. 2 with a sealing barrier.

FIG. 5 is another example of the brake shoe assembly of FIG. 2 with a sealing barrier.

FIG. 6 is another example of the brake shoe assembly of FIG. 2 with a sealing barrier.

FIG. 7 is another example of the brake shoe assembly of FIG. 2 with a sealing barrier.

### DETAILED DESCRIPTION OF THE PREFERRED EMBODIMENT

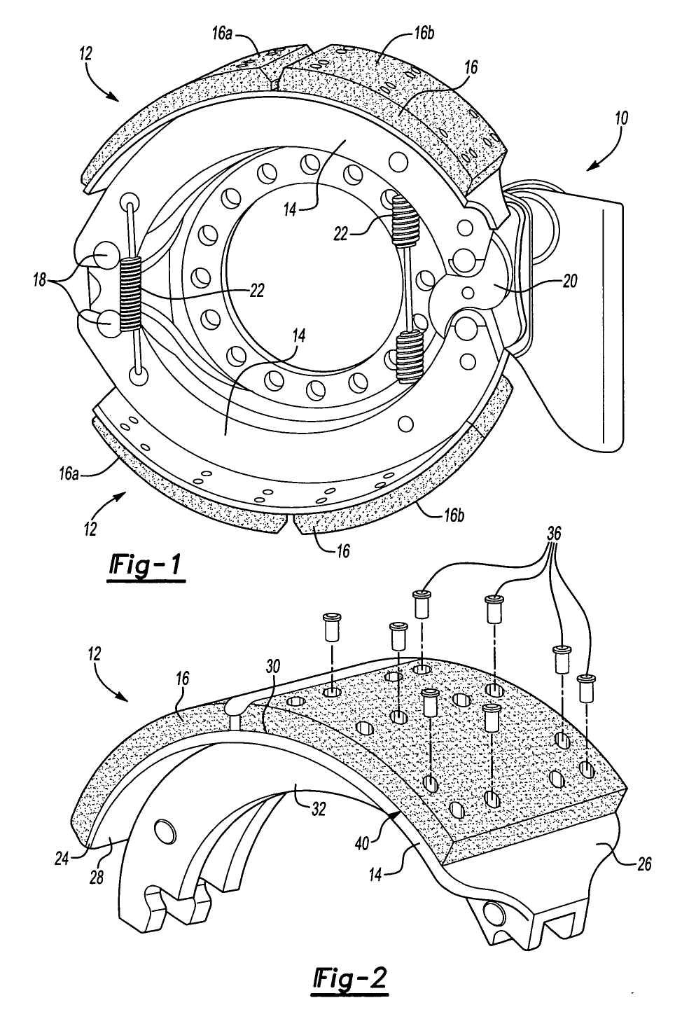

A brake assembly 10 is shown in FIG. 1. The brake assembly includes brake pads or brake shoes 12, with each brake shoe 12 having a support plate or brake table 14 and a friction lining 16. The friction lining 16 is formed as a lining block that is fixed to the brake table 14. In the example shown, first 16a and second 16b lining blocks are fixed to the brake table 14, however, a single lining block or additional lining blocks could also be used.

Each brake shoe 12 is fixed at one end with an anchor pin 18. An actuator 20 is associated with an opposite end of each brake shoe 12 and is used to move the brake shoes 12 into engagement with a rotating brake component such as a brake drum (not shown), for example. In the example shown, the actuator 20 comprises an S-cam that moves the brake shoes 12 in response to a brake command. Other types of actuators 20 could also be used such as wedges or hydraulic cylinders, for example. Resilient members 22 assist in returning the brake shoes 12 to a non-applied position, as known.

One brake shoe 12 is shown in greater detail in FIG. 2. It should be understood that the other brake shoe 12 would be similarly configured. The brake table 14 includes a plate portion 24 having an outer surface 26 and an inner surface 28. The outer surface 26 is an arcuate surface that generally corresponds to an arcuate surface 30 on the friction lining 16. The brake table 14 includes a web structure 32 that extends outwardly from the inner surface 28. The web structure 32 cooperates with the anchor pins 18 and actuator 20 as described above.

A plurality of fasteners 36 is used to secure the friction lining 16 to the brake table 14. In the example shown, rivets are used, however, other types of fasteners could also be used. The fasteners 36 are relied upon to provide a sufficient attachment force between the friction lining 16 and the brake table 14.

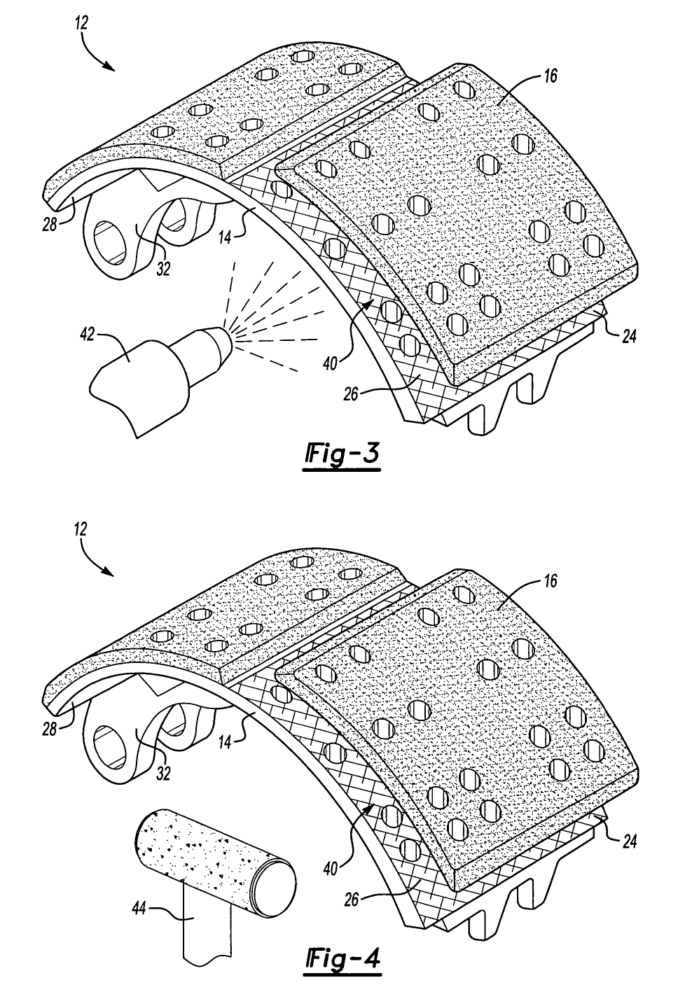

A sealing barrier 40 is formed between the friction lining 16 and the brake table 14 to prevent ingress of contaminants, which leads to the occurrence of rust and corrosion. The sealing barrier 40 comprises a sealant that, in additional to sealing, provides an additional benefit of filling in any surface irregularities in the friction lining 16 and/or the brake table 14 generated during manufacturing. The sealing barrier 40 is primarily relied upon to provide a sealing effect; however, the sealant may additionally provide some adhesion between the brake table 14 and friction lining 16. However, any adhesion provided by the sealant is not relied upon for securement purposes. The fasteners 36 are solely relied upon to provide sufficient securement between the brake table 14 and friction lining 16. Examples of the sealing barrier 40 are shown in FIGS. 3-7.

In the example shown in FIG. 3, the sealing barrier 40 comprises a liquid material that is initially sprayed onto one or both of the brake table 14 and friction lining 16. A tool 42 such as a nozzle or other similar mechanism is used to spray the liquid material onto the brake table 14 and/or friction lining 16. As shown, the liquid material covers a substantial portion of the outer surface 26 of the plate portion 24. After spraying, the friction lining 16 is attached to the brake table 14. This configuration may require a curing process, which would involve a specified time for drying, a heating step, and/or a specified time for heating.

The liquid material is at least one of a sealant and adhesive that may or may not include color additives. In one example, the liquid material is a silicon based material that is sprayed onto a painted or unpainted surface on the brake table 14. After the liquid has dried, the sealing barrier 40 is formed and will seal moisture and contaminants out while still being able to flex in response to heating/cooling, and can flex in response to brake torque deflections.

The example shown in FIG. 4 is similar to that of FIG. 3, but shows that the liquid material is rolled onto at least one of the brake table 14 and friction lining 16. A tool 44 such as a rolling wheel or other similar mechanism is used to roll the liquid material over the outer surface 26 of the plate portion 24. Again, after the liquid has dried, the sealing barrier 40 is formed.

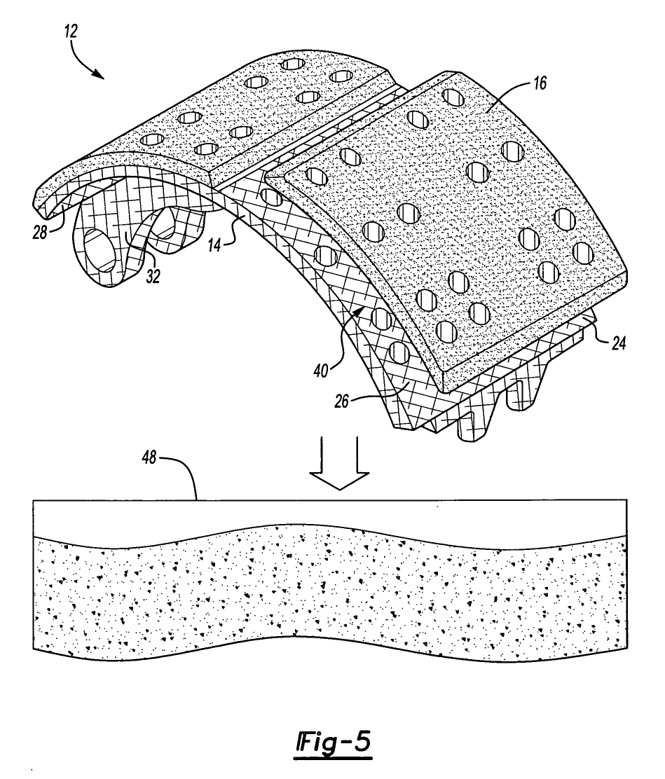

The example shown in FIG. 5 has the brake table 14 being dipped into a vat or other similar container 48 that is filled with the liquid material. This dipping action completely coats the brake table 14 including both the plate portion 24 and the web structure 32. The liquid dries to form the sealing barrier 40.

In the example shown in FIG. 6, the liquid material is applied as a bead of material 50 that covers an initial portion of at least one of the friction lining 16 and brake table 14. The bead of material 50 is located in a position such that moisture cannot enter between the brake table 14 and the friction lining 16. A tool 52 such as an applicator or other similar mechanism is used to apply the bead of material 50. After application of the bead of material 50, the friction lining 16 is attached to the brake table 14. The attachment force of the fasteners 36 (FIG. 2) causes the bead of material 50 to expand or spread out over a larger portion of the outer surface 28 of the brake table 14. This more evenly distributes the liquid material, and once the liquid material dries, the sealing barrier 40 is formed.

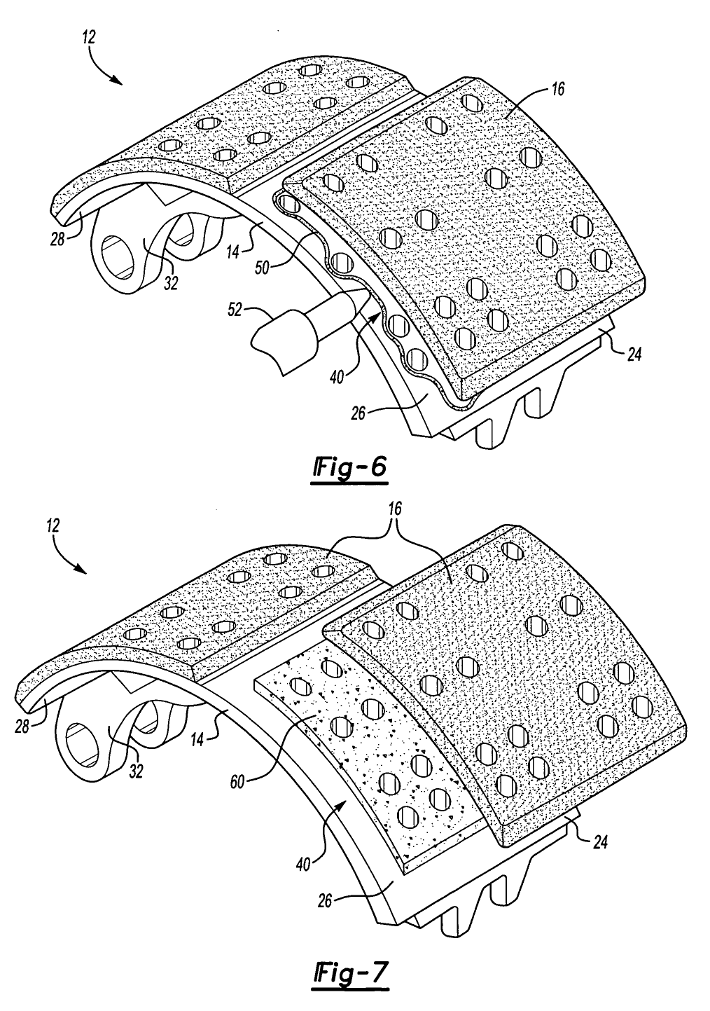

In the example shown in FIG. 7, the sealing barrier 40 is formed as a flexible sealing gasket 60. The flexible sealing gasket 60 is a non-asbestos material, and is preferably made from a resilient material such as rubber, cork, or other similar type of material. The flexible sealing gasket 60 is positioned directly between the friction lining 16 and the outer surface 28 of the brake table 14. The flexible sealing gasket 60 is solely relied upon to provide the sealing barrier 40 and does not serve to attach the friction lining 16 to the brake table 14. The fasteners 36 are relied upon to secure the friction lining 16 to the brake table 14 with the flexible sealing gasket 60 being sandwiched therebetween. The flexible sealing gasket 60 may or may not include openings for receiving the fasteners 36, and can be sized to cover the entire outer surface 26 of the brake table 14 or only a portion of the brake table 14 as needed.

For any of the embodiments discussed above, the brake shoe 12 can be easily re-fitted with a new friction lining once a friction lining has worn to a level such that the friction lining needs to be replaced. To re-fit the brake shoe 12, a worn friction lining is removed from the brake table 14. A sealing barrier 40 is applied to at least one of the outer surface 28 of the brake table 14 and the new friction lining, and then the new friction lining is fastened onto the original brake table 14. The sealing barrier 40 can be applied in any one of the manners discussed above.

The subject sealing barrier 40 prevents moisture intrusion and rust/corrosion from forming between the friction lining 16 and brake table 14, which results in improved brake performance and longer friction lining life. Further, the subject sealing barrier 40 allows the brake shoe 12 to be easily re-fitted with new friction linings. The sealing bearing 40 is primarily relied upon to provide a sealing feature but may provide some adhesion between the brake table 14 and the friction lining 16. The fasteners 36 are solely relied upon to secure the friction lining 16 to the brake table. If the sealing barrier 40 does provide some adhesion, residual portions of the sealing barrier may have to be removed from the brake table 14 prior to re-fitting the brake table 14 with new friction linings.

It should be understood that while the sealing barrier 40 is shown in the figures as being associated with a brake shoe for a drum brake assembly, the sealing barrier could be used with pad or shoe assemblies for other types of brakes.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A brake component assembly comprising:
a support plate;
a friction lining mounted to said support plate with a plurality of fasteners; and
a liquid material initially applied to at least one of said support plate and friction lining and forming a sealing barrier between said support plate and said friction lining.

2. The brake component assembly according to claim 1 wherein said liquid material comprises a sprayable liquid that is applied to the at least one of said support plate and said friction lining.

3. The brake component assembly according to claim 1 wherein said liquid material comprises a bead of one of an adhesive and a sealant that is applied to cover only a portion of the at least one of said support plate and said friction lining.

4. The brake component assembly according to claim 1 wherein said support plate comprises a dipable component and said liquid material comprises one of an adhesive and a sealant, said dipable component being completely coated with the one of the adhesive and the sealant in a dipping application.

5. The brake component assembly according to claim 1 wherein said liquid material is applied to the at least one of said support plate and said friction lining in a rolling application.

6. The brake component assembly according to claim 1 wherein said sealing barrier comprises a silicon based material.

7. The brake component assembly according to claim 1 wherein said plurality of fasteners extends into said friction lining and said support plate.

8. The brake component assembly according to claim 7 wherein said support plate comprises a brake table having an arcuate surface that corresponds generally to an arcuate surface on said friction material.

9. The brake component assembly according to claim 1 wherein said friction lining comprises at least one lining block comprised of a friction material that has a first arcuate surface, and wherein said support plate comprises a brake table having a second arcuate surface that generally corresponds to said first arcuate surface and a web structure extending away from said second arcuate surface, said web structure being mountable to a brake actuating component.

10. The brake component assembly according to claim 9 wherein said liquid material completely coats said brake table including coating said second arcuate surface and said web structure.

11. The brake component assembly according to claim 9 wherein said liquid material comprises a sprayable liquid that is applied to at least one of said first and said second arcuate surfaces during a spraying application.

12. The brake component assembly according to claim 9 wherein said liquid material is applied to at least one of said first and said second arcuate surfaces during a rolling application.

13. The brake component assembly according to claim 9 wherein said liquid material comprises a bead of at least one of an adhesive and a sealant that is applied to at least one of said first and said second arcuate surfaces.

14. The brake component assembly according to claim 9 wherein said plurality of rivets is solely used for attaching said at least one lining block to said brake table and where said sealing barrier is solely used to provide a sealed interface between said friction material and said brake table.

15. A method of assembling a brake shoe assembly comprising the steps of:
(a) applying a liquid material to at least one of a brake table and friction lining block to form a sealing barrier; and
(b) fastening the friction lining block to the brake table with a plurality of fasteners.

16. The method according to claim 15 wherein step (a) includes spraying the liquid material onto the at least one of the brake table and friction lining block.

17. The method according to claim 15 wherein step (a) includes rolling the liquid material onto the at least one of the brake table and friction lining block.

18. The method according to claim 15 wherein step (a) includes applying the liquid material onto the at least one of the brake table and friction lining block as a bead of material.

19. The method according to claim 18 including the step of causing the bead of material to flow in a plurality of directions to cover a greater portion of the at least one of the brake table and friction lining block during step (b).

20. The method according to claim 15 wherein the brake table includes a plate portion with an arcuate surface for receiving the friction lining block and a web structure extending outwardly from the plate portion, and wherein step (a) includes dipping the support plate into the liquid material to completely coat the plate portion and the web structure.

21. A method for re-fitting a brake component assembly comprising the steps of:
(a) removing a worn lining block from a brake table;
(b) applying a liquid material to at least one of a new lining block and the brake table to form a sealing barrier; and
(c) fastening the new lining block to the brake table.

22. The method according to claim 21 wherein step (b) includes spraying the liquid material onto the one of the new lining block and the brake table.

23. The method according to claim 21 wherein step (b) includes dipping the at least one of the new lining block and the brake table in the liquid material.

24. The method according to claim 21 wherein step (b) includes rolling the liquid material onto the one of the new lining block and the brake table.

25. The method according to claim 21 wherein step (b) includes applying a bead of liquid material onto the one of the new lining block and the brake table.

26. The method according to claim 21 wherein the liquid material is a silicon based material.

27. A brake component assembly comprises:
a support plate;
a friction lining mounted to said support plate with a plurality of fasteners; and
a sealing barrier positioned between said support plate and said friction lining, said sealing barrier comprising a flexible gasket that is solely used to provide a sealed interface between said friction lining and said support plate.

28. The brake component assembly according to claim 27 wherein said gasket comprises a non-asbestos resilient material.

29. The brake component assembly according to claim 28 wherein said non-asbestos resilient material comprises one of a rubber material and a cork material.

30. A method for assembling a brake shoe assembly comprising the steps of:
(a) placing a sealing gasket over an outer surface of a brake table; and
(b) providing a sealed interface for the brake table by fastening a friction lining block to the brake table such that the gasket is sandwiched directly between the friction lining block and the brake table, with the sealing gasket being used solely to provide the sealed interface.

31. The method according to claim 30 including forming the sealing gasket from a non-asbestos resilient material.

32. The method according to claim 31 wherein the non-asbestos resilient material is one of a rubber material and a cork material.

33. The method according to claim 30 including the steps of removing the friction lining and the sealing gasket from the brake table after the friction lining has worn to a predetermined wear level, placing a new sealing gasket on the brake table, and fastening a new friction lining to the brake table.
